(19) United States
(12) Patent Application Publication
(10) Pub. No.: US 2015/0210207 A1
(43) Pub. Date: Jul. 30, 2015

(54) Vehicle Fog Lamp

(71) Applicant: Fuji Jukogyo Kabushiki Kaisha, Tokyo (JP)

(72) Inventors: Kiyoteru MORI, Tokyo (JP); Kentaro Yamasaki, Tokyo (JP); Yu Tomoeda, Tokyo (JP); Mototatsu Isaji, Tokyo (JP)

(21) Appl. No.: 14/593,899

(22) Filed: Jan. 9, 2015

(30) Foreign Application Priority Data
Jan. 24, 2014 (JP) 2014-011596

(51) Int. Cl. B60Q 1/20

(52) U.S. Cl. CPC B60Q 1/20

(57) ABSTRACT

A vehicle fog lamp includes a light source and reflective surface sections surrounding the light source. A screen light distribution pattern formed by illuminating light that is emitted from the light source and is reflected on the reflective surface section is divided into an outer pattern part and an inner pattern part. An upper end part of the outer pattern part is disposed above an upper end part of the inner pattern part.

### CROSS-REFERENCE TO RELATED APPLICATION

The present application claims priority from Japanese Patent Application No. 2014-011596 filed on Jan. 24, 2014, the entire contents of which are hereby incorporated by reference.

### BACKGROUND

1. Technical Field

The present disclosure relates to a vehicle fog lamp, and particularly relates to the vehicle fog lamp with improved distant visibility.

2. Related Art

Conventionally, disposing various lamps, such as fog lamps in addition to head lamps is known for vehicle lamps. Note that the term “fog lamp” as used herein refers to a lamp generally used in order to improve front visibility at the time of bad weather, such as fog, rain, and/or snow.

Technologies for improving the visibility of such fog lamps are disclosed in the following patent documents.

Japanese Unexamined Patent Application Publication (JP-A) No. H10-250460 discloses drive lights for curve lighting are provided in addition to headlights. Specifically, with reference to FIGS. 1 and 3 and description of these drawings of JP-A No. H10-250460, visibility is improved by disposing fog lights 2 at the vehicle front end, and, for example, at the time of traveling a right curve, increasing voltage supplied to the right-side light 2.

In the technology disclosed in JP-A No. H08-087903, with reference to FIG. 3 and description of the drawing thereof, a fundamental plane of a reflective surface 2 of a vehicle fog lamp 1 has a shape obtained by modifying an elliptic paraboloid that is an ellipse in cross section perpendicular to a main optical axis of the reflective surface 2. Thus, the reflective surface 2 forms a clear line that is used for the basis of a horizontal cutline. JP-A No. 2009-173189 discloses a vehicle provided with cornering lamps. Specifically, with reference to FIGS. 1 and 2 and description of these drawings of JP-A No. 2009-173189, color temperature of a first light source that constitutes a cornering lamp 20 is set higher than color temperature of headlights, and color temperature of a second light source is set higher than that of the first light source. Therefore, an effect of improving visibility in an obliquely forward direction of the vehicle can be obtained.

However, the above technologies disclosed may sometimes be difficult to efficiently improve the visibility.

Specifically, as for JP-A No. H10-250460, since it is necessary to control the voltage supplied from the control unit 3 to the short-distance drive lights 2 according to operation of a steering wheel by a user, and it is necessary to have a complicated control mechanism in order to improve the visibility, cost may increase. In addition, with reference to FIG. 1 of JP-A No. H10-250460, although a base line AB of the light 2 is widely extended sideways, the forward visibility is not examined.

In JP-A No. H08-087903, although the modification is made to part of the reflector that constitutes the fog lamp, the distant visibility thereof is not discussed.

In JP-A No. 2009-173189, although it is possible to improve the visibility, the number of components of the entire vehicle increases because the cornering lamps that are dedicated to increase the visibility at the time of cornering are essential.

### SUMMARY OF THE INVENTION

The present disclosure is made in view of the above-described situations, and a purpose of the present disclosure is to provide a simply-configured vehicle fog lamp with improved distant visibility.

According to one aspect of the present disclosure, a vehicle fog lamp that is disposed in a front end part of a vehicle and illuminates light forward is provided. The vehicle fog lamp forms a screen light distribution pattern formed by illuminating the light. The screen light distribution pattern is divided by a vertical line into an outer pattern part located outside the vertical line and an inner pattern part located inside the vertical line. The outer pattern part has an upper end part that is disposed above an upper end part of the inner pattern part.

### BRIEF DESCRIPTION OF THE DRAWINGS

The present disclosure is illustrated by way of example and not by way of limitation in the figures of the accompanying drawings, in which the like reference numerals indicate like elements and in which:

FIG. 1 is a view illustrating a vehicle fog lamp according to an example of the present disclosure, where a vehicle provided with the fog lamp is illustrated in a perspective view;

FIGS. 2A to 2C are views illustrating the vehicle fog lamp according to the example, where FIG. 2A is a front view of the fog lamp, FIG. 2B is a cross-sectional view of the fog lamp, and FIG. 2C is an enlarged cross-sectional view illustrating a main part of the fog lamp;

FIGS. 3A and 3B are views illustrating the vehicle fog lamp according to the example, where FIG. 3A is illustrates a screen light distribution pattern, and FIG. 3B illustrating a road surface light distribution pattern;

FIGS. 4A and 4B are views illustrating the vehicle fog lamp according to the example, where FIG. 4A is a conceptual diagram illustrating a situation where the vehicle provided with the fog lamp travels in a left curve, and FIG. 4B is a conceptual diagram illustrating a situation where the vehicle provided with the fog lamp travels in a right curve; and

FIGS. 5A to 5C are cross-sectional views illustrating vehicle fog lamps according to other examples of the present disclosure.

### DETAILED DESCRIPTION

Hereinafter, one example of a vehicle fog lamp is described. In the following description, the terms “left” and “right” or “leftward” and “rightward” as used herein refer to directions with respect to a forward traveling direction of a vehicle 10. Note that relative positions of vehicle components may be described using the terms “outside” and “inside” or “outward” and “inward.”

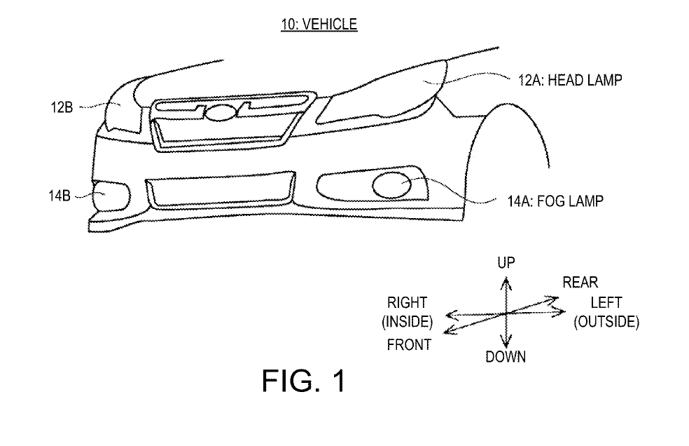

With reference to FIG. 1, a vehicle fog lamp (hereinafter, simply referred to as “fog lamp”) of this example is described. FIG. 1 is a perspective view illustrating a vehicle front part of the vehicle 10 to which fog lamps 14A and 14B of this example are mounted.

Head lamps 12A and 12B are disposed in a front end part of the vehicle 10. The head lamp 12A is disposed in a left end part, and the head lamp 12B is disposed in a right end part. In the following description, the head lamp 12A and the head lamp 12B are collectively referred to as “the head lamps 12.” Each head lamp 12 has a function to illuminate or emit a low beam used at the time of normal traveling, and a function to illuminate or emit a high beam that illuminates locations more distant from the illuminating locations of the low beam.

The fog lamps 14A and 14B are mounted in the front end part of the vehicle 10, below the head lamps 12A and 12B, respectively. In the following description, the fog lamp 14A and the fog lamp 14B are collectively referred to as “the fog lamps 14.” A fundamental function of the fog lamp 14 is to forwardly emit light, such as white light, at the time of bad weather, such as fog, so that visibility is secured while reducing reflections to the user of the emitted light. In addition, the fog lamp 14 also has a function to improve the conspicuity to oncoming vehicles, etc.

An illuminating angle of each fog lamp 14 to the left and right is set to be wider than that of the head lamp 12. This is for securing the visibility widely. On the other hand, a vertical illuminating angle of each fog lamp 14 is set to be narrower than that of the head lamp 12. This is for reducing that lights reflected on moistures in the air reach the user.

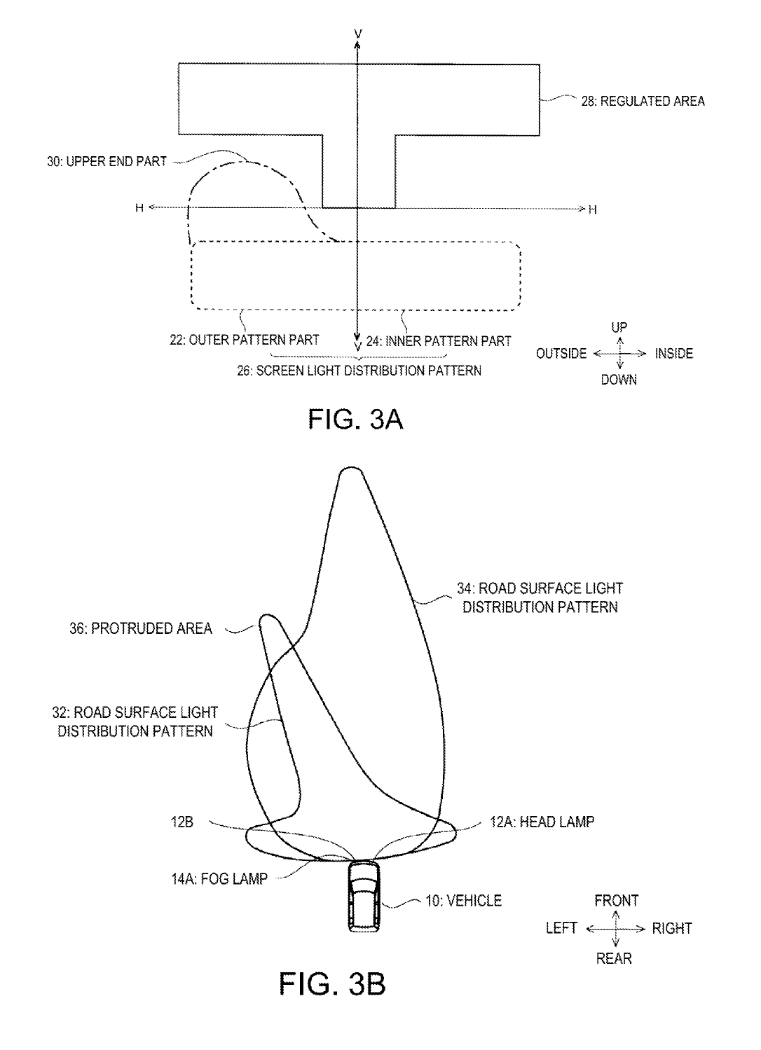

In this example, a light distribution pattern emitted from each fog lamp 14 is not horizontally uniform, but an outside part of the light distribution pattern is disposed above the inner part in order to secure distant visibility. This function will be described in detail with reference to FIGS. 3A and 3B and other drawings.

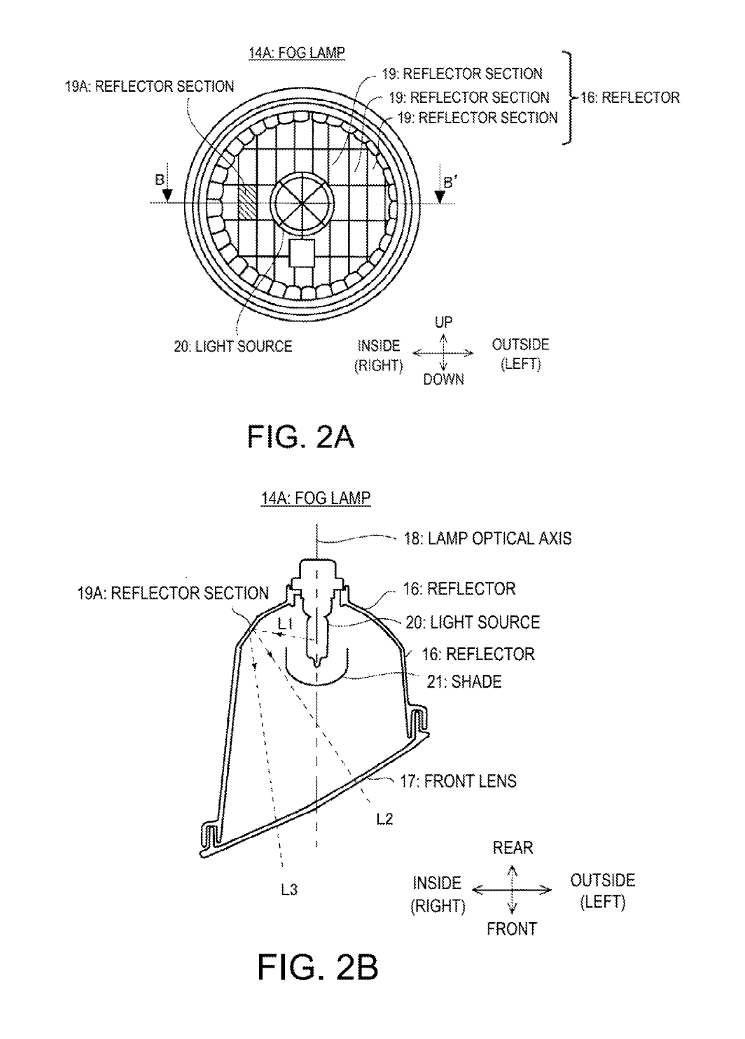

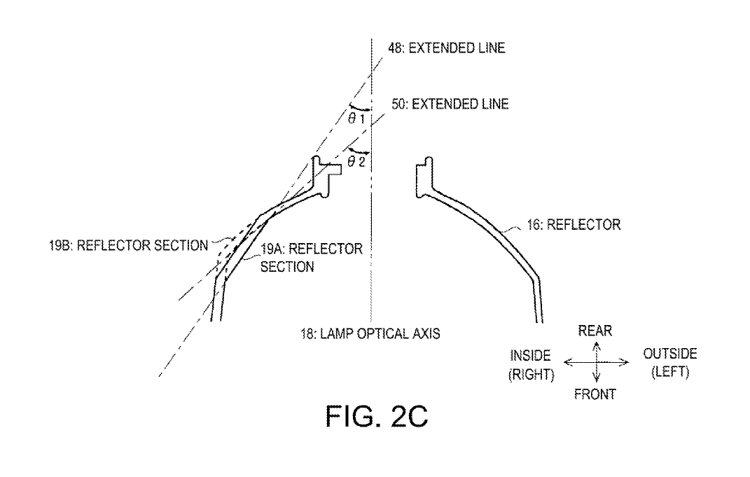

With reference to FIGS. 2A to 2C, a configuration of the fog lamp 14A is described in detail. FIG. 2A is an elevational view of the fog lamp 14A viewed from the front, FIG. 2B is a cross-sectional view taken along a line B-B′ of FIG. 2A, and FIG. 2C is an enlarged cross-sectional view.

Since FIGS. 2A to 2C illustrate the fog lamp 14A disposed at the left of the vehicle 10 illustrated in FIG. 1, an inward direction of this drawing indicates a rightward direction of the vehicle 10, while an outward direction indicates a leftward direction of the vehicle 10.

As illustrated in FIGS. 2A and 2B, fog lamp 14A includes a light source 20 that emits light, a reflector 16 that reflects the emitted light forward, and a front lens 17 that covers a front opening of the reflector 16. In the fog lamp 14A, the light emitted from the light source 20 is reflected on reflector sections 19 (reflective surface sections) of the reflector 16, and then transmits through the front lens 17 to be emitted forward of the vehicle 10.

The light source 20 is comprised of a light bulb (e.g., an LED bulb), and has a function to emit light that illuminates forward of the vehicle 10. The light source 20 emits light not only forward but also emits light leftward and rightward. The light emitted from the light source 20 is emitted forward along a lamp optical axis 18. A shade 21 is made of light-resistant material having a cup shape with a rearward opening. The shade 21 has a function to partially block the light emitted from the light source 20 so that the light does not illuminate areas other than predetermined reflective surfaces. The shade 21 also has a function to block light emitted forward from the light source 20.

The reflector 16 has a cup shape with a forward opening, and an inner surface of the reflector 16 has the reflective surface sections where plating or painting is applied. A fundamental function of the reflector 16 is to reflect the light emitted from the light source 20 at predetermined angles. For example, the reflector 16 is made of synthetic resin, and is integrally formed by injection molding.

The inner surface of the reflector 16 is provided with a plurality of reflector sections 19 (reflective surface sections) each having a polygonal shape, and the size and oriented angle of each reflector section 19 are adjusted so that the light emitted from the light source 20 is reflected to a predetermined location. The spatial relationship between each reflector section 19 and the lamp optical axis 18 is not identical to the spatial relationship of other reflector sections 19. Here, reflector sections 19 disposed forward are closer to a more parallel relation with respect to the lamp optical axis 18 than reflector sections 19 disposed rearward.

The front lens 17 is made of transparent synthetic resin to transmit the light emitted from the light source 20 therethrough, and covers the front opening of the reflector 16. The front lens 17 is inclined to conform to the end shape of the vehicle 10.

In this example, the visibility of the light emitted from the fog lamp 14A is improved by modifying the shape of a reflector section 19A that is located inward from the light source 20 and is located at the identical location to the light source 20 in the vertical direction, and direction parallel to the lamp optical axis 18 of the light source 20 (hereinafter, referred to as “the front-and-rear direction”). In FIG. 2A the reflector section 19A is disposed at a hatched area. Specifically, the reflector section 19A has a smaller inclination angle from the lamp optical axis 18 compared to other reflector sections 19 disposed at the same position in the front-and-rear direction.

As illustrated in FIG. 2B, if no modification is made to the reflector section 19A, light L1 emitted from the light source 20 is reflected on the reflector section 19A and then transmits the front lens 17 to be emitted forward as reflected light L3. On the other hand, in the present disclosure, since the inclination of the reflector section 19A is made smaller, the light emitted from the light source 20 is reflected on the reflector section 19A and then transmits through the front lens 17 to be emitted forward of the vehicle 10 as reflected light L2. As clearly seen from this drawing, in the fog lamp 14A of this example, the inclination angle of the reflector section 19A is made smaller to increase light portion that is emitted outwardly.

With reference to FIG. 2C, a configuration of the reflector section 19A is described in detail. An intersecting angle θ1 between an extended line 48 of an inner surface of the reflector section 19A and the lamp optical axis 18 is smaller than an intersecting angle θ2 between an extended line 50 of an inner surface of another reflector section 19B and the lamp optical axes 18. This configuration achieves an effect of preferentially directing the light emitted from the light source 20 outwardly, as described above.

Describing the above structure in other words, the inner surface of the rear part of the reflector 16 has a shape substantially like a cup bottom, and part where the reflector section 19A is located projects inwardly. In another view, the reflector section 19A is located closer to the light source 20 than other reflector sections 19 located at the same position in the front-and-rear direction.

With reference to FIGS. 3A to 3C, a light distribution pattern that is generated by the fog lamp 14A having the above configuration is described. FIG. 3A illustrates a screen light distribution, and FIG. 3B illustrates a road surface light distribution. In FIG. 3A, a line H-H extending in the lateral direction is a horizontal line passing through the center of the light source (light bulb) of the fog lamp 14A. On the other hand, a line V-V extending in the vertical direction is a vertical line passing through the center of the light source (light bulb) of the fog lamp 14A. Note that the screen light distribution refers to an image projected when light is emitted on a screen oriented vertically so that the screen projection surface opposes to the front of the vehicle. FIG. 3A illustrates a screen light distribution pattern 26 that is formed by illuminating the fog lamp 14A. Note that a regulated area 28 illustrated in FIG. 3A is an area defined as an upper limit by the U.S. SAE standards, and the standards define that the screen light distribution of the fog lamp 14A shall not reach the regulated area 28.

The screen light distribution pattern 26 is comprised of an outer pattern part 22 located outside the line V-V, and an inner pattern part 24 located inside the line V-V. In this example, an upper end part 30 of the outer pattern part 22 is disposed above an upper end of the inner pattern part 24. In FIG. 3A, a normal screen light distribution pattern is surrounded by a dotted line, and a pattern part added in order to achieve this example is indicated by a dashed dotted line. With the above configuration, since the light emitted from the fog lamp 14A illuminates far away forward and outward, the visibility improves. The light distribution pattern section indicated by the dashed dotted line is formed by the reflected light that is reflected on the reflector section 19A illustrated in FIG. 2B.

Further, in this example, the upper end part 30 of the outer pattern part 22 is disposed above a line H-H that is a horizontal line. Thus, the effect of improving the distant visibility as described above significantly increases.

Note that, since the upper end part 30 of the outer pattern part 22 is disposed outside (below) the regulated area 28, the fog lamp 14A of this example conforms to the standards described above. Further, most part of the screen light distribution pattern 26 is disposed below the line H-H. This is for preventing the light emitted from the fog lamp 14A from causing adverse effects on operators of vehicles located forward of the vehicle 10.

With reference to FIG. 3B, a road surface light distribution pattern 32 formed by the fog lamp 14A is described. Note that the term “road surface light distribution pattern” as used herein refers to a pattern formed by the light emitted from light source(s) illuminating on a road surface. Here, a road surface light distribution pattern 34 is formed by low-beam illumination of the head lamp 12A and the head lamp 12B. On the other hand, the road surface light distribution pattern 32 is formed only by the fog lamp 14A disposed at the left end of the vehicle 10.

The road surface light distribution pattern 34 is formed comparatively broadly forward of the vehicle 10 in order to secure the front visibility of the operator at the time of traveling at night. Note that the road surface light distribution pattern 34 is defined on an assumption that the vehicle 10 travels on the right side of a road. Therefore, a left side part of the road surface light distribution pattern 34 is defined narrower than the right side part. In other words, a cutoff line of the left side part of the road surface light distribution pattern 34 is disposed rearward from the cutoff line of the right side part. This is for reducing an adverse effect of the low beam of the head lamp 12B given to operators of oncoming vehicles.

Most part of the road surface light distribution pattern 32 formed by the fog lamp 14A is distributed on a road surface part immediately in front of the vehicle 10, and another part extends in a narrow and long shape, obliquely forward and leftward of the vehicle 10. In addition, the extended narrow and long part of the road surface light distribution pattern 32 is partially located forward and outward of the cutoff line of the road surface light distribution pattern 34 by the head lamps 12A and 12B to form a protruded area 36. Note that the term “cutoff line” as used herein refers to a boundary between the light distribution pattern (illuminated area) and a dark area.

Thus, the visibility by the light emitted from the fog lamp 14A improves by disposing the part of the road surface light distribution pattern 32 by the fog lamp 14A forward of the cutoff line of the low beam as the protruded area 36. In particular, since the protruded area 36 is provided on the oncoming vehicle lane side, the visibility of the oncoming vehicles and the conspicuity from the oncoming vehicles improve.

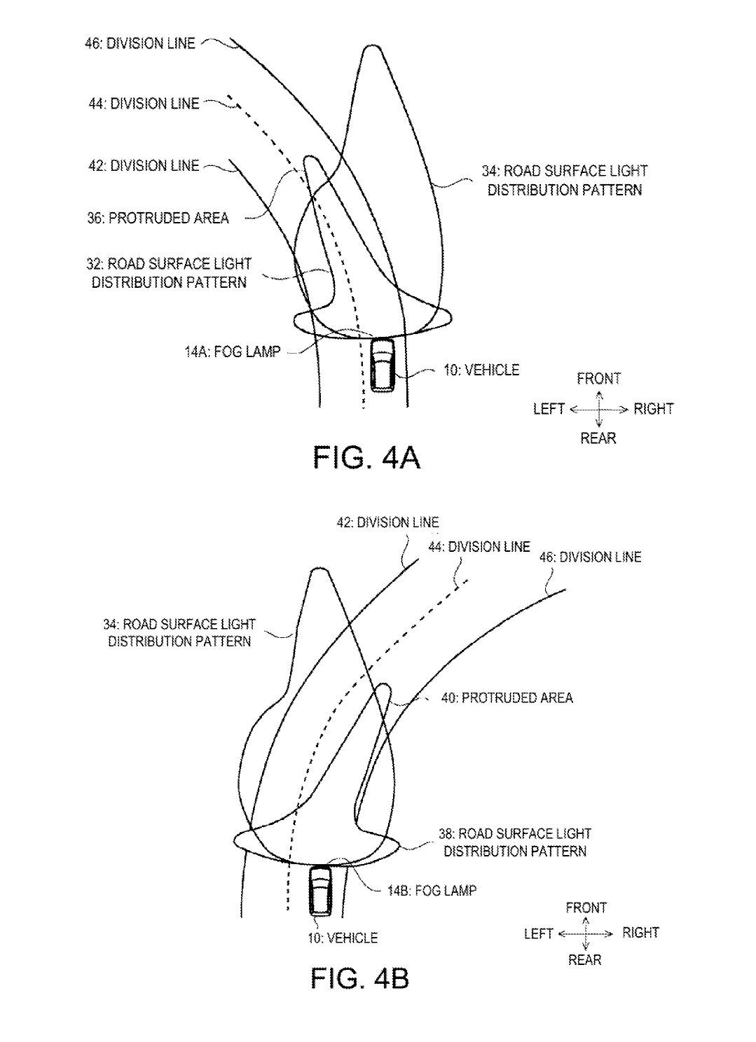

With reference to FIGS. 4A and 4B, a case where the vehicle 10 having the fog lamps 14A and 14B travels in a curve is described. FIG. 4A illustrates a situation where the vehicle 10 travels in a left curve, and FIG. 4B illustrates a situation where the vehicle 10 travels in a right curve. Here, a case where the vehicle 10 travels on the right side of the road is particularly illustrated.

In FIG. 4A, from left, division lines 42, 44 and 46 are defined on the road surface where the vehicle 10 travels. The division lines 42 and 46 are lines that define left and right ends of the road, respectively, and the division line 44 is a line that indicates the center of the road.

When the vehicle 10 travels in the left curve, it is not easy to visually recognize oncoming vehicles traveling on the opposite lane located on the left side of the vehicle 10. Further, the shape of the road surface light distribution pattern 34 of the head lamps 12 is formed so that a left side part where the oncoming vehicles exist is smaller, taking the oncoming vehicles in consideration. Therefore, when traveling in the left curve at nighttime, it may be difficult to visually recognize the oncoming vehicles, resulting in a situation where an accident may occur comparatively often at the time of traveling.

In this example, the road surface light distribution pattern 32 of the fog lamp 14A formed on the left side of the front end of the vehicle 10 is extended leftward and forward of the vehicle 10 as described above. Further, the tip end of the road surface light distribution pattern 32 protrudes outward (forward) of the cutoff line of the road surface light distribution pattern 34 of the head lamps to form the protruded area 36. Therefore, it is easy to visually recognize the vehicles that travel on the opposite lane. In addition, the conspicuity of the vehicle 10 itself by the oncoming vehicles is also improved. Specifically, improving the visibility of the locations ahead of the curve and the road shoulder allows stopping vehicles, obstacles, pedestrians and other objects that are in front of the vehicle 10 to be discovered earlier, thereby preventing an accident.

As illustrated in FIG. 4B, when the vehicle 10 travels in a right curve, a right side part of the road surface light distribution pattern 34 of the head lamps is secured to be comparatively large. Therefore, the visibility is better than the case of the left curve described above. However, the fog lamp 14B disposed on the right side of the front end of the vehicle 10 illuminates rightward and forward in this example in order to increase safety. Specifically, part of the road surface light distribution pattern 38 formed by the fog lamp 14B is extended rightward and forward. Further, a tip end part of the road surface light distribution pattern 38 forms a protruded area 40 that protrudes outside of the cutoff line of the road surface light distribution pattern 34 of the head lamps. Therefore, even if the vehicle 10 travels the right curve, the fog lamp 14B illuminating forward improves the visibility in this example, thereby preventing an accident.

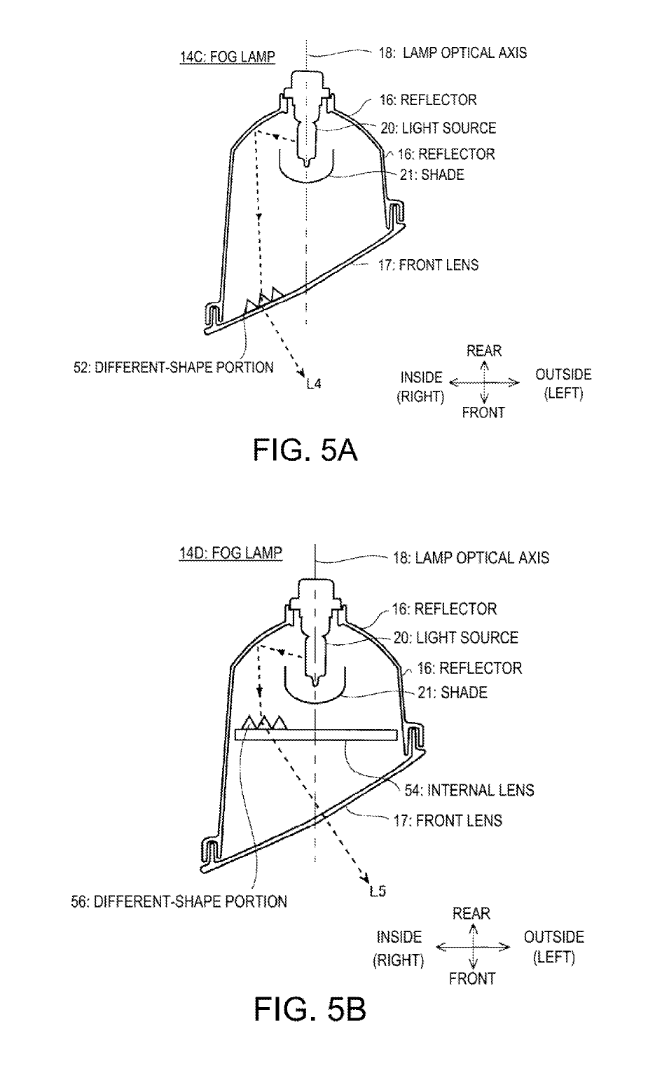

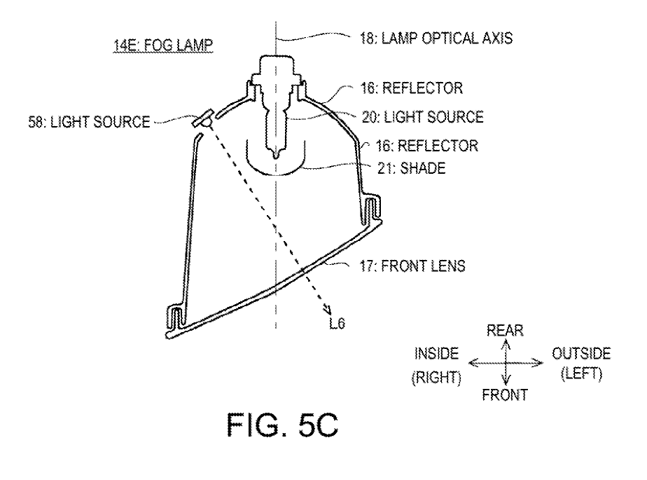

With reference to FIGS. 5A to 5C, other examples to achieve the light distribution pattern of this example are described. The fog lamp 14A illustrated in FIG. 2B achieves the pattern shape illustrated in FIG. 3A by making the inclinations of the reflector section 19A different. However, such a light distribution pattern shape can be realized by other configurations. Other configurations are illustrated in FIGS. 5A to 5C, respectively.

A fog lamp 14C illustrated in FIG. 5A achieves the shape of the outer pattern part 22 by forming deformed portions 52 on part of the front lenses 17. Specifically, the deformed portion 52 is formed by forming a convex shape on part of a principal surface inside the front lens 17. The particular shape of the deformed portion 52 includes a shape that projects or recesses in a thickness direction. Accordingly, light L4 emitted from the light source 20 is reflected on the inner surface of the reflector 16 and is then refracted outwardly by the deformed portions 52 to be emitted forward of the vehicle 10. Therefore, the shape of the outer pattern part 22 illustrated in FIG. 3A is achieved. In this case, the shape of the reflector 16 may be a normal shape having a substantially bowl shape.

In a fog lamp 14D illustrated in FIG. 5B, an internal lens 54 is disposed forward of the light source 20 inside the reflector 16. The internal lens 54 is made of, for example, synthetic resin, and is formed by injection molding so that it is disposed opposing to the light source 20. Here, deformed portions 56 are formed in part of the back side of a principal surface of the internal lens 54. The deformed portion 56 may have a shape that projects or recesses in a thickness direction. Alternatively, the deformed portion 56 may be formed on the front side of the principal surface of the internal lens 54. Accordingly, light L5 emitted from the light source 20 is reflected on the inner surface of the reflector 16 and is then refracted outwardly by the deformed portions 56 of the internal lens 54 so that the light L5 transmits the front lens 17 and is emitted outside. Thus, the shape of the outer pattern part (FIG. 3A) is achieved similar to the above.

The fog lamp 14E illustrated in FIG. 5C is provided with another light source 58 (second light source) that is separately provided from the light source 20 (first light source). An LED bulb may be adopted as the light source 58. Here, the light source 20 emits light that constitutes both the outer pattern part 22 and the inner pattern part 24 illustrated in FIG. 3A. On the other hand, the light source 58 emits light L6 that constitutes the outer pattern part 22, and particularly emits light that constitutes the upper part of the outer pattern part 22 (the part indicated by the dotted line). Therefore, the shape of the outer pattern part (FIG. 3A) is achieved as described above.

Note that the configurations described above for realizing the outer pattern part of this example may selectively be combined and used. That is, the technical matters for realizing the outside pattern of the fog lamps illustrated in FIG. 2(B) and FIGS. 5A to 5C can selectively be combined and used.

This example described above may also be changed or modified as follows, for example.

While the above examples are for the case where the vehicle 10 travels on the right side of the road, the present invention may be applied to the case where the vehicle 10 may travels on the left side. In this case, the orientations of the light distribution pattern are horizontally reversed in each drawing.

According to the above examples, the upper end part of the outer pattern part that constitutes the screen light distribution pattern of the vehicle fog lamp is disposed above the upper end of the inner pattern part. Thus, since the vehicle fog lamp illuminates further distant locations outwardly and forwardly, the distant visibility improves.

According to the above examples, the upper end part of the outer pattern part may be disposed higher by designing the angle of one reflective surface section of the vehicle fog lamp different from other reflective surface sections disposed at other locations at the same height. Thus, it is possible to acquire a desirable light distribution pattern shape with a simple configuration, without requiring dedicated components.

In the foregoing specification, specific above examples of the present disclosure have been described. However, one of ordinary skill in the technique appreciates that various modifications and changes can be performed without departing from the scope of the present disclosure as set forth in the claims below. Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

1. A vehicle fog lamp that is disposed in a front end part of a vehicle and illuminates light forward, the vehicle fog lamp being configured to form a screen light distribution pattern by illuminating the light, the screen light distribution pattern being divided by a vertical line into an outer pattern part located outside direction of the vehicle from the vertical line and an inner pattern part located inside direction of the vehicle from the vertical line, and the outer pattern part having an upper end part that is disposed above an upper end part of the inner pattern part.

2. The vehicle fog lamp of claim 1, wherein the upper end part of the outer pattern part is disposed above a horizontal line.

3. The vehicle fog lamp of claim 1, wherein part of a road surface light distribution pattern formed by emitting the light on a road surface is disposed outside an outer edge of a road surface light distribution pattern formed by emitting low beams of head lamps provided with the vehicle on the road surface.

4. The vehicle fog lamp of claim 2, wherein part of a road surface light distribution pattern formed by emitting the light on a road surface is disposed outside an outer edge of a road surface light distribution pattern formed by emitting low beams of head lamps provided with the vehicle on the road surface.

5. The vehicle fog lamp of claim 1, comprising:
a light source; and
reflective surface sections disposed so as to surround the light source,
wherein an intersecting angle between an extended line of the reflective surface section that is disposed sideways from the light source and reflects the light to constitute the outer pattern part, and an optical axis of the fog lamp is smaller than an intersecting angle between an extended line of the reflective surface section disposed at other side location, and the optical axis.

6. The vehicle fog lamp of claim 2, comprising:
a light source; and
reflective surface sections disposed so as to surround the light source,
wherein an intersecting angle between an extended line of the reflective surface section that is disposed sideways from the light source and reflects the light to constitute the outer pattern part, and an optical axis of the fog lamp is smaller than an intersecting angle between an extended line of the reflective surface section disposed at other side location, and the optical axis.

7. The vehicle fog lamp of claim 3, comprising:
a light source; and
reflective surface sections disposed so as to surround the light source,
wherein an intersecting angle between an extended line of the reflective surface section that is disposed sideways from the light source and reflects the light to constitute the outer pattern part, and an optical axis of the fog lamp is smaller than an intersecting angle between an extended line of the reflective surface section disposed at other side location, and the optical axis.

8. The vehicle fog lamp of claim 4, comprising:
a light source; and
reflective surface sections disposed so as to surround the light source,
wherein an intersecting angle between an extended line of the reflective surface section that is disposed sideways from the light source and reflects the light to constitute the outer pattern part, and an optical axis of the fog lamp is smaller than an intersecting angle between an extended line of the reflective surface section disposed at other side location, and the optical axis.

9. The vehicle fog lamp of claim 1, comprising:
a light source; and
a front lens disposed forward of the light source,
wherein part of the front lens through which the light constituting the outer pattern part passes is formed in at least one deformed portion.

10. The vehicle fog lamp of claim 2, comprising:
a light source; and
a front lens disposed forward of the light source,
wherein part of the front lens through which the light constituting the outer pattern part passes is formed in at least one deformed portion.

11. The vehicle fog lamp of claim 3, comprising:
a light source; and
a front lens disposed forward of the light source,
wherein part of the front lens through which the light constituting the outer pattern part passes is formed in at least one deformed portion.

12. The vehicle fog lamp of claim 4, comprising:
a light source; and
a front lens disposed forward of the light source,
wherein part of the front lens through which the light constituting the outer pattern part passes is formed in at least one deformed portion.

13. The vehicle fog lamp of claim 1, comprising:
a light source; and
an internal lens disposed forward of the light source,
wherein part of the internal lens through which the light constituting the outer pattern part passes is formed in at least one deformed portion.

14. The vehicle fog lamp of claim 2, comprising:
a light source; and
an internal lens disposed forward of the light source,
wherein part of the internal lens through which the light constituting the outer pattern part passes is formed in at least one deformed portion.

15. The vehicle fog lamp of claim 3, comprising:
a light source; and
an internal lens disposed forward of the light source,
wherein part of the internal lens through which the light constituting the outer pattern part passes is formed in at least one deformed portion.

16. The vehicle fog lamp of claim 4, comprising:
a light source; and
an internal lens disposed forward of the light source,
wherein part of the internal lens through which the light constituting the outer pattern part passes is formed in at least one deformed portion.

17. The vehicle fog lamp of claim 1, comprising:
a first light source that emits light constituting both an outer pattern part and an inner pattern part; and
a second light source that emits light constituting only the outer pattern part.

18. The vehicle fog lamp of claim 2, comprising:
a first light source that emits light constituting both an outer pattern part and an inner pattern part; and
a second light source that emits light constituting only the outer pattern part.

19. The vehicle fog lamp of claim 3, comprising:
a first light source that emits light constituting both an outer pattern part and an inner pattern part; and
a second light source that emits light constituting only the outer pattern part.

20. The vehicle fog lamp of claim 4, comprising:
a first light source that emits light constituting both an outer pattern part and an inner pattern part; and
a second light source that emits light constituting only the outer pattern part.
